(19) United States
(12) Patent Application Publication
(10) Pub. No.: US 2026/0122543 A1
(43) Pub. Date: Apr. 30, 2026

(54) METHOD FOR INTER-PLMN CELL RESELECTION IN RRC_INACTIVE WITHOUT TRANSITION TO RRC_CONNECTED OR TO RRC_IDLE

(71) Applicant: Nokia Technologies Oy, Espoo (FI)

(72) Inventors: Ayaz AHMED, Bangalore (IN); Daniela LASELVA, Aalborg (DK); Srinivasan SELVAGANAPATHY, Bangalore (IN); Philippe GODIN, Massy (FR); Jussi-Pekka KOSKINEN, Oulu (FI); Jedrzej STANCZAK, Wroclaw (PL)

(21) Appl. No.: 19/117,227

(22) PCT Filed: Aug. 29, 2023
(86) PCT No.: PCT/FI2023/050493

§ 371 Date: Mar. 31, 2025

(30) Foreign Application Priority Data
Nov. 1, 2022 (IN) 202241062329

(51) Int. Cl. H04W 36/08; H04W 76/27

(52) U.S. Cl. CPC H04W 36/08; H04W 76/27

(57) ABSTRACT

An apparatus, comprising: at least one processor; and at least one memory storing instructions that, when executed by the at least one processor, cause the apparatus at least to: receive an indication from a network cell, the indication comprising at least one public land mobile network cell that supports inter public land mobile network radio resource control inactive state cell reselection; and reselect another network cell while in radio resource control inactive state and without transitioning to a radio resource control idle state, the another network cell being among the indicated at least one public land mobile network cell that supports inter public land mobile network radio resource control inactive state cell reselection.

### TECHNICAL FIELD

The examples and non-limiting example embodiments relate generally to communications and, more particularly, to a method for inter-PLMN cell reselection in RRC_INACTIVE without transition to RRC_CONNECTED or to RRC_IDLE.

### BACKGROUND

It is known for a user equipment to connect to a non-terrestrial network and to a terrestrial network.

### SUMMARY

In accordance with an aspect, an apparatus includes at least one processor; and at least one memory storing instructions that, when executed by the at least one processor, cause the apparatus at least to: receive an indication from a network cell, the indication comprising at least one public land mobile network cell that supports inter public land mobile network radio resource control inactive state cell reselection; and reselect another network cell while in radio resource control inactive state and without transitioning to a radio resource control idle state, the another network cell being among the indicated at least one public land mobile network cell that supports inter public land mobile network radio resource control inactive state cell reselection.

In accordance with an aspect, an apparatus includes at least one processor; and at least one memory storing instructions that, when executed by the at least one processor, cause the apparatus at least to: receive, from a terminal device, a cause value configured to be used for a non-access stratum registration update procedure when the terminal device while in radio resource control inactive state, and without transitioning to a radio resource control idle state, is reselecting another network cell from a network cell; store the cause value within a resume request; retain the terminal device in the radio resource control inactive state with an updated suspend configuration; and transmit, to the terminal device, a physical downlink shared channel transmission comprising a registration accept message.

In accordance with an aspect, an apparatus includes at least one processor; and at least one memory storing instructions that, when executed by the at least one processor, cause the apparatus at least to: receive, with a network node from a terminal device, a non-access stratum registration message, the network node providing access to a network cell; and transmit, to the terminal device, an indication comprising at least one public land mobile network cell that supports inter public land mobile network radio resource control inactive state cell reselection; wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

In accordance with an aspect, an apparatus includes at least one processor; and at least one memory storing instructions that, when executed by the at least one processor, cause the apparatus at least to: receive a registration request from a network node providing access to a network cell; and transmit, to the terminal device either directly or through the network node, an indication comprising at least one public land mobile network cell that supports inter public land mobile network radio resource control inactive state cell reselection; wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection.

In accordance with an aspect, an apparatus includes at least one processor; and at least one memory storing instructions that, when executed by the at least one processor, cause the apparatus at least to: receive, from a network node providing access to another network cell, a path switch request while the terminal device is in radio resource control inactive state, the terminal device having reselected the another network cell while in radio resource control inactive state and without transitioning to a radio resource control idle state, from a network cell; receive, from the network node providing access to the another network cell, a next generation application protocol uplink non-access stratum transport message comprising a mobility registration update non-access stratum message; retain at least one protocol data unit session and at least one data radio bearer setup prior to transitioning the terminal device to inactive state without performing radio resource control reestablishment, based on the mobility registration update non-access stratum message; and transmit, to the terminal device either directly or through a network node providing access to the another network cell, a registration accept message.

In accordance with an aspect, an apparatus includes at least one processor; and at least one memory storing instructions that, when executed by the at least one processor, cause the apparatus at least to: receive an indication from a network cell, the indication signaling support of inter public land mobile network radio resource control inactive state cell reselection; and reselect, based on the indication, another network cell while in radio resource control inactive state and without transitioning to a radio resource control idle state.

In accordance with an aspect, an apparatus includes at least one processor; and at least one memory storing instructions that, when executed by the at least one processor, cause the apparatus at least to: receive, from a terminal device, a cause value configured to be used for a registration update procedure when the terminal device while in radio resource control inactive state, and without transitioning to a radio resource control idle state, is reselecting another network cell from a network cell; store the cause value within a resume request; retain the terminal device in the radio resource control inactive state; and transmit, to the terminal device, a physical downlink shared channel transmission comprising a registration accept message.

In accordance with an aspect, an apparatus includes at least one processor; and at least one memory storing instructions that, when executed by the at least one processor, cause the apparatus at least to: receive, with a network node from a terminal device, a registration message, the network node providing access to a network cell; and transmit, to the terminal device, an indication signaling support of inter public land mobile network radio resource control inactive state cell reselection; wherein the indication is configured to be used with the terminal device to reselect another network cell while the terminal device is in radio resource control inactive state and without transitioning to a radio resource control idle state.

In accordance with an aspect, an apparatus includes at least one processor; and at least one memory storing instructions that, when executed by the at least one processor, cause the apparatus at least to: receive a registration request from a network node providing access to a network cell; and transmit, to the terminal device either directly or through the network node, an indication signaling support of inter public land mobile network radio resource control inactive state cell reselection; wherein the indication is configured to be used with the terminal device to reselect another network cell while in radio resource control inactive state and without transitioning to a radio resource control idle state.

In accordance with an aspect, an apparatus includes at least one processor; and at least one memory storing instructions that, when executed by the at least one processor, cause the apparatus at least to: receive, from a network node providing access to another network cell, a path switch request while the terminal device is in radio resource control inactive state, the terminal device having reselected the another network cell while in radio resource control inactive state and without transitioning to a radio resource control idle state, from a network cell; receive, from the network node providing access to the another network cell, a mobility registration update message; retain at least one protocol data unit session and at least one data radio bearer setup prior to transitioning the terminal device to inactive state without performing radio resource control reestablishment, based on the mobility registration update message; and transmit, to the terminal device either directly or through a network node providing access to the another network cell, a registration accept message.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 depicts an NR RRC state machine with RRC state transitions.

FIG. 3 depicts a signaling diagram for a first embodiment.

FIG. 4 depicts a signaling diagram for an alternate embodiment.

FIG. 5 is an example apparatus configured to implement the examples described herein.

FIG. 6 shows a representation of an example of non-volatile memory media.

FIG. 7 is an example method implementing the examples described herein, performed with a terminal device.

FIG. 8 is an example method implementing the examples described herein, performed with a network node.

FIG. 9 is an example method implementing the examples described herein, performed with a network node.

FIG. 10 is an example method implementing the examples described herein, performed with an access and mobility management function.

FIG. 11 is an example method implementing the examples described herein, performed with an access and mobility management function.

FIG. 12 is an example method implementing the examples described herein, performed with a terminal device.

FIG. 13 is an example method implementing the examples described herein, performed with a network node.

FIG. 14 is an example method implementing the examples described herein, performed with a network node.

FIG. 15 is an example method implementing the examples described herein, performed with an access and mobility management function.

FIG. 16 is an example method implementing the examples described herein, performed with an access and mobility management function.

### DETAILED DESCRIPTION OF EXAMPLE EMBODIMENTS

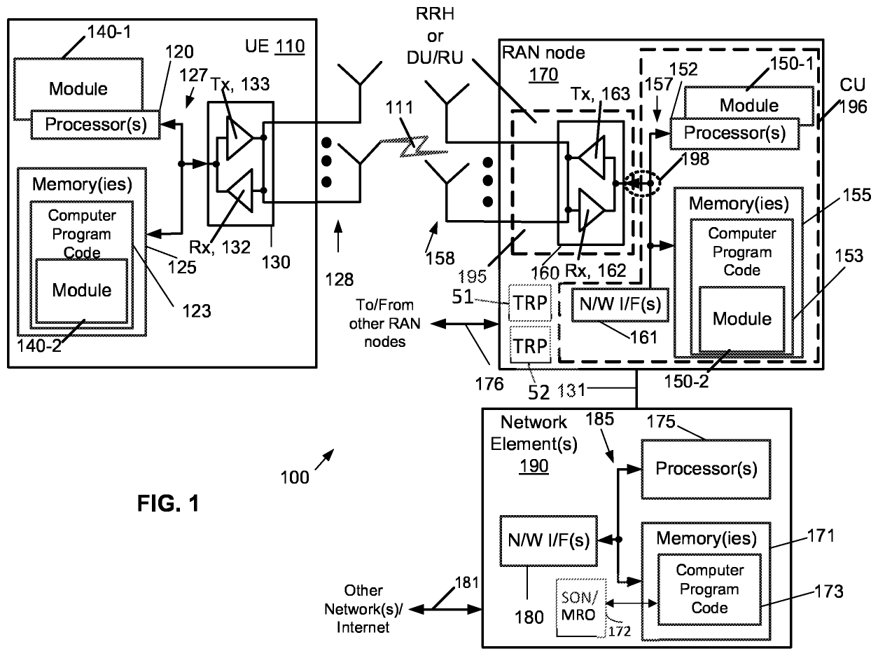

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node. The examples described herein are considered for intra-RAT environment scenarios.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including a method for inter-PLMN cell reselection in RRC_INACTIVE without transition to RRC_CONNECTED or to RRC_IDLE. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein are related to enhancements to the connection resume procedure in 5G NR in the context of NTN mobility use cases.

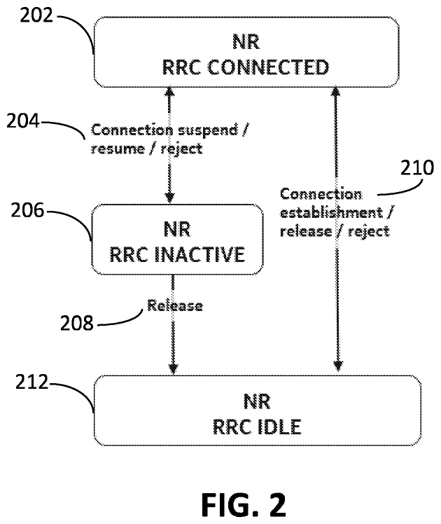

FIG. 2 depicts an NR RRC state machine with RRC state transitions. The RRC_INACTIVE state (206) was introduced in 3GPP NR Rel-15 complementing the existing states, RRC_CONNECTED (202) and RRC_IDLE (212), with the goal of lean signaling and energy-efficient support of NR services and use cases.

The RRC_INACTIVE state (206) enables the network to quickly resume a suspended RRC connection (refer to 204) and start the transmission of small or sporadic data with a much lower initial access delay and associated signaling overhead as compared to the RRC_IDLE state (212).

As further shown in FIG. 2, the UE 110 transitions from NR RRC_INACTIVE state (206) to NR RRC_IDLE state (212) during release (208), and the UE 110 transitions between NR RRC_CONNECTED state (202) and NR RRC_IDLE state (212) during connection, establishment, release, or reject (210).

As compared to UE 110 in RRC_CONNECTED state (202), the RRC_INACTIVE state (206) minimizes mobility signaling both to the RAN and to the core network, since the UE remains in CM-CONNECTED state. A UE in RRC_INACTIVE state (206) can move within an area configured by the RAN known as the RAN notification area (RNA) without any notification to the network, using a unique identifier-'Inactive-RNTI (I-RNTI)'-when accessing to the network. The RNA can be configured to cover a single or multiple cells and is contained within the registration area (RA) configured by the AMF.

A serving gNB (e.g. 170) allocates I-RNTI to a UE 110 as a part of suspendConfig within a RRC Release message when moving the UE from RRC_CONNECTED (202) to RRC_INACTIVE state (206). The I-RNTI is used at the network side to identify both UE 110 and the gNB 170 which hosts the UE context (last serving gNB).

I-RNTI may have a length of 40 bits (full I-RNTI) or a length of 24 bits (short I-RNTI). A UE reads the information in the SIB1 to decide to either use short I-RNTI or full I-RNTI when resuming the connection.

UE 110 initiates a RAN notification area update (RNAU) either periodically (as configured) and when it re-selects a cell that is not part of the configured RAN notification area (RNA). An RNA must be configured within the CN registration area (RA). When a UE 110 moves out of the configured registration area (RA), the UE 110 initiates a mobility registration area update (RAU), to inform the AMF that it has entered a new RA.

In the 3GPP TR 38.821-‘Solutions for NR to support NTN’, Idle/Inactive mode UE procedures as specified for a TN system are considered as a baseline for NTN; however enhancements are not precluded.

One of the objectives of the Rel-18 NR NTN Enhancements (NR_NTN_enh) WI [Reference: RP-222654], is the support of service continuity or seamless UE mobility between a NTN and a TN, which includes the UE mobility in RRC_INACTIVE state.

4.1.4 NTN-TN and NTN-NTN mobility and service continuity enhancements. This work considers existing methods from NR TN as well as the outcome of the Rel-17 NR NTN WI outcome as a baseline for NTN-TN mobility. This includes specifying NTN-TN and NTN-NTN measurement/mobility and service continuity enhancements [RAN2,RAN3,RAN4]. For NTN-NTN mobility, this includes specifying cell reselection enhancements for an earth moving cell, where the timing based and location-based cell reselection for quasi-earth fixed cell in Rel-17 can be considered as the starting point. [RAN2, RAN3, RAN4]. This work further includes specifying NTN-NTN handover enhancement for RRC_CONNECTED UEs in the quasi-earth-fixed cell and earth-moving cell to reduce the signaling overhead. [RAN2, RAN3]. This work further includes specifying cell reselection enhancements for RRC_IDLE/INACTIVE UEs to reduce UE power consumption (NTN-TN mobility is prioritized). [RAN2, RAN3, RAN4]. This work further includes studying and, if needed, specifying enhancement to Xn[/NG] signaling to support feeder link switch-over, CHO, e.g. exchange of necessary information between gNBs. [RAN3].

3GPP SA working group 2 (SA2) has made the following agreements related to NTN. NTN satellite types GEO, MEO, LEO and TN are considered different RAT types. Each RAT type has to be configured with a non-overlapping registration area (RA) or tracking area (TA). The above implies that, for NTN and TN overlapping scenarios, the RA or TA of NTN and TN must be clearly defined. However, from a RAN2 perspective, NR NTN GEO, MEO, LEO cells and NR TN cells are considered as Intra-RAT cells.

Further, the deployment options for NTN as identified in 3GPP TR 38.821 include the following: NTN deployed with PLMN different from TN, NTN and TN deployed with equivalent PLMN (EPLMN), and NTN and TN deployed with common PLMN.

However, the inventors of the herein described examples have identified some limitation to support UE mobility in RRC_INACTIVE state for all possible deployment scenarios, details of which are listed below.

The examples described herein consider the scenario of a UE (connected to NTN) in RRC_INACTIVE state that re-selects to a TN cell. It is assumed that both NTN and TN are of an NR RAT type, and are connected by an Xn interface. It is further assumed that the networks belong to different PLMNs which is a possible NTN-TN deployment scenario.

As per the SA2 agreements listed previously, the NTN and TN cells are expected to be part of different registration areas (RA); this implies that the re-selected TN cell would not be part of the last serving gNB configured RNA. This means that upon reselection to the TN cell of the same PLMN as the NTN cell, currently the UE would need to initiate both a RAN notification area update procedure (RNAU) and a mobility registration update procedure (MRU). MRU is a NAS procedure to inform the AMF that it has entered a new RA.

As per the existing specification (see Section 4.1 in TS 38.304), if a registration update procedure is triggered by a UE in RRC_INACTIVE state due to cell reselection to an inter-PLMN cell, the UE transitions to RRC_IDLE first and then re-establishes the RRC connection; the registration request (NAS message) is then initiated by the UE as part of an RRCSetupComplete message, which is forwarded to the AMF within an NGAP Initial UE Message message.

As described in Section 4.1 in TS 38.304, “When the UE selects a new PLMN or SNPN, the UE transitions from RRC_INACTIVE to RRC_IDLE, as specified in TS 24.501.”

Therefore, in the assumed scenario of a different PLMN, whenever the TN cell of a new PLMN is reselected, currently the UE has to discard the stored RRC Inactive context assigned by the NTN network, and re-establish it from scratch in the new TN cell.

Described herein is a solution that enables a) RNAU and MRU procedures due to the reselection to an inter-PLMN (intra-RAT) cell of a different RA/TA to be executed successfully in the RRC Inactive state without requiring the transition to RRC Idle or RRC connected, while also preserving the PDU sessions and configured DRBs, and b) the network to indicate to the UE the support of such inter-PLMN connection resume, enabling the UE to attempt inter-PLMN connection resume when it is supported. It is noted that such procedure applies in-network related capabilities and procedures, which may not be always present. For example, the following would be implemented at the network side: AS Inactive UE context retrieving from a neighbor gNB belonging to a different PLMN, core network C-plane and U-plane path switch between different AMFs serving different PLMNs, NAS UE context transfer when old and new AMFs differ, etc.

The above listed are the core enhancements the examples described herein address. The solution described herein can reduce the UE's power consumption and the network's power consumption, signaling overhead, and latency. Such support can enable more efficient and smoother transitions between the NTN and the TN, where such transitions can happen quite often for an NTN UE.

RNAU and NAS registration procedures may be combined jointly in the RRC inactive resume procedure, with an aim to optimize coinciding procedures. However these procedures does not address how to handle RNAU and RAU procedures by avoiding an unwanted transition to RRC_CONNECTED state.

One of the differences between the examples described herein and previous developments is that, described herein is a method for cell re-selection in RRC_INACTIVE state to a cell belonging to different RA/TA, RNA and different PLMN without transition to RRC_CONNECTED. Previously developed methods do not implement this solution. Also, the method described herein enables the network to indicate the support of inter-PLMN resume, and thereby a UE attempts the inter-PLMN connection resume when it is supported by the network. The examples described herein are applicable to an intra-RAT scenario.

The method described herein aims to address the problems mentioned previously, and enables a UE in RRC_INACTIVE state, while connected to an NR (NTN) cell, to reselect an inter-PLMN NR (TN) cell without transitioning to RRC_IDLE or to RRC_CONNECTED, while preserving the PDU sessions and DRBs configured in NTN PLMN to be continued after cell reselection to the TN cell. The embodiment is also applicable for TN to NTN cell reselection in RRC_INACTIVE state, NTN to NTN cell reselection in RRC_INACTIVE state, and TN to TN cell reselection in RRC_INACTIVE state, and in general, reselection to a second network cell in RRC_INACTIVE state from a first network cell. Further, the examples described herein are applicable to an intra-RAT scenario.

The following are the example steps for realizing the example solution embodiment:
1. For UE capable of NTN and TN connectivity, as part of the attach or initial registration procedure, the serving AMF (home PLMN) can indicate to the UE the support of inter-PLMN RRC_INACTIVE state cell re-selection including the list of supported PLMNs. This indication together with the supported PLMN list can be provided within the NAS Registration Accept message carried over an existing NGAP message such as the initial context setup request message or DL NAS transport. This enables the UE to attempt connection resume after inter-PLMN cell re-selection when the core network has indicated support for it, otherwise the UE transitions to RRC Idle (as per the legacy behavior). It is to be noted that inter-PLMN RRC_INACTIVE state cell re-selection may be configured or enabled for other inter-PLMN mobility use cases as well in addition to NTN.
2. The serving cell can broadcast the support of inter-PLMN RRC_INACTIVE state mobility in SIB1 or in SIB19 (NTN specific) or any other suitable SIB. This enables the UE to attempt connection resume after inter-PLMN cell re-selection when both the RAN and core network supports it, otherwise the UE transitions to RRC Idle. Alternatively the NW can inform an entity (e.g. the UE) support of inter-PLMN RRC_INACTIVE state mobility in an RRC Release message with suspend configuration i.e. in RRC_CONNECTED to RRC_INACTIVE transition (as captured in alternate embodiment in FIG. 2). In another example the NW configures (via dedicated and/or broadcast signaling) the UE to perform an RRC resume procedure in case of inter-PLMN cell re-selection.
3. When reselecting a new cell as part of cell reselection across PLMNs, the UE may decide to reselect a cell based on its support for the inter-PLMN RRC-INACTIVE state.
4. A UE in RRC_INACTIVE state, upon inter-PLMN cell-reselection to a PLMN belonging to the list of supported PLMNs as signaled by the network, can initiate an SDT procedure for MRU in case SRB is configured for SDT i.e. the NW allows the UE to initiate the SDT procedure for NAS signaling. The UE can use the existing RRCResumeRequest message with a new cause value (e.g. ra-Update), as a trigger for the gNB of the new serving cell to perform XnAP UE context retrieval from the last serving gNB of a different PLMN (if new gNB and last serving gNB are different).

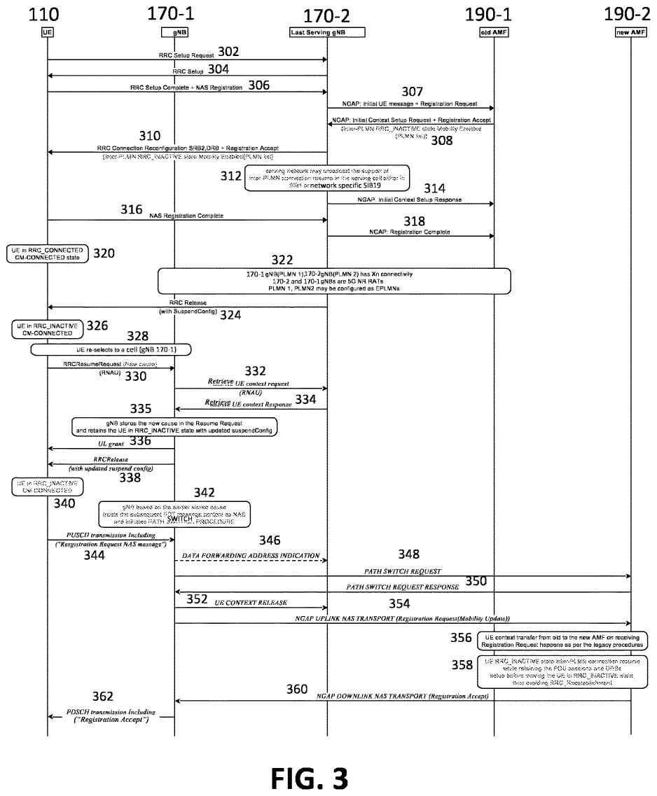

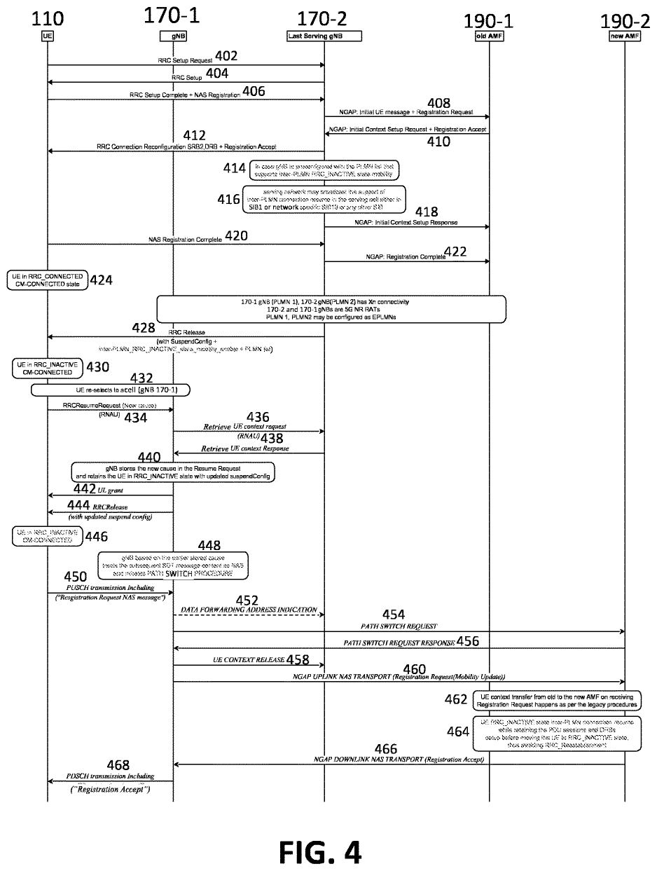

The new cause value in the RRC Resume Request message shall be an indication for the network node of the re-selected cell that the NAS registration update procedure is expected to be followed. The network node of the re-selected cell will then, based at least partially on the cause value, store the new cause value and retain the UE in RRC_INACTIVE state with an updated suspend configuration. Refer for example to items 330 and 335 of FIG. 3, and items 434 and 440 of FIG. 4.

If the msg3 size is sufficient to accommodate the NAS message, the UE includes the ‘Registration Request with mobility update’ NAS message in Msg3 of 4step-RACH based SDT, otherwise it sends a BSR in msg3 to ask for an additional UL grant.

As an alternative, PRACH resources (preambles, ROs) dedicated to the SDT procedure for this use case of MRU can be configured by the cell so that the UE can indicate to the network the need for a size of Msg3 of the 4-step RACH which can fit the NAS message.

Alternatively the new resume cause is provided in an RRC Resume Request using LCID dedicated for this purpose. For instance, dedicated CCCH SDU LCID(s) for this purpose could be used, i.e., the LCID that is used to indicate the CCCH SDU (RRCResumeRequest in this case).
5. The gNB of the new serving cell (TN cell), upon receiving a ‘NAS registration update’ message as an SDT payload, extracts the NAS message and forwards it to the new AMF using an NGAP ‘UPLINK NAS TRANSPORT’ message, after the PATH SWITCH REQUEST procedure. As a result, for the UE in RRC_INACTIVE state, the NAS mobility registration update procedure due to inter-PLMN cell re-selection is executed without an RRC state transition while the UE remains in RRC_INACTIVE state.
6. In case the AMF serving the new serving TN gNB is different than the old serving AMF, then the new AMF requests the UE context transfer from the old AMF (serving last serving NTN gNB).
7. Even in the case of a different AMF serving the new serving gNB (TN in this example), the above mechanism enables the new network to preserve the PDU sessions/DRBs associated with the UE, potentially avoiding an RRC connection Re-establishment.
8. NGAP downlink NAS transport and DL SDT may be used to forward the registration accept NAS message from the AMF to the UE. Currently in Rel-17 SDT, the NAS message transfer is only supported in the UL.

In summary, described herein is a method to enable continuation of RRC_INACTIVE state for an inter-PLMN cell change scenario ‘from AMF during registration procedure’ or ‘from RAN during UE transition to RRC_INACTIVE state’. A list of PLMNs where this feature is activated is signaled. Also described herein is a method at the UE to continue in RRC_INACTIVE state when reselecting to a cell of another PLMN which is configured to support inter-PLMN RRC_INACTIVE mobility. Also described herein is a method for UE triggering the inter-PLMN mobility update procedure for context transfer from an old RAN node to a new RAN node, and also for context transfer from an old AMF to a new AMF, to resume the RRC connection and bearers. Also described herein is a method for UE triggering the SDT procedure for the inter-PLMN mobility update procedure in RRC_INACTIVE state.

The signaling diagram for a first embodiment is shown in FIG. 3. Key aspects include those shown at item 308 (“Inter-PLMN RRC_INACTIVE state Mobility Enabled (PLMN list))”), item 310 (“Inter-PLMN RRC_INACTIVE state Mobility Enabled (PLMN list)”), item 312 (“serving network may broadcast the support of inter-PLMN connection resume in the serving cell either in SIB1 or network specific SIB19”), item 330 (“(New cause)”), item 340 (“UE in RRC_INACTIVE CM-CONNECTED”), item 342 (“gNB based on the earlier stored cause treats the subsequent SDT message content as NAS and initiates PATH SWITCH PROCEDURE”), item 358 (“UE RRC_INACTIVE state inter-PLMN connection resume while retaining the PDU sessions and DRBs setup before moving the UE to RRC_INACTIVE state, thus avoiding RRC_Reestablishment”), and item 362 (“(“Registration Accept”)”).

At 302, the UE 110 transmits an RRC setup request to the last serving gNB 170-2 (e.g. an NTN gNB 170-2). Last serving gNB 170-2 may also be referred to as a serving network node, which becomes a last serving network node following the UE 110 reselecting to another cell to which another network node (e.g. gNB 170-1) provides access. At 304, the last serving gNB 170-2 transmits to the UE 110 an RRC setup message. At 306, the UE 110 transmits to the last serving gNB 170-2 an RRC setup complete and NAS registration message. At 307, the last serving gNB 170-2 transmits to the old AMF 190-1 an NGAP initial UE message and registration request. At 308, the old AMF 190-1 transmits to the last serving gNB 170-2 an NGAP initial context setup request and registration accept message with an indication of inter-PLMN RRC_INACTIVE state mobility enabled including a PLMN list. At 310, the last serving gNB 170-2 transmits to the UE 110 an RRC connection reconfiguration SRB2, DRB and registration accept message, including an indication of inter-PLMN RRC_INACTIVE state mobility enabled message (PLMN list). At 312 as performed with the last serving gNB 170-2, the serving network may broadcast the support of inter-PLMN connection resume in the serving cell either in SIB1 or network (e.g. NTN) specific SIB19.

At 314, the last serving gNB 170-2 transmits to the old AMF 190-1 an NGAP initial context setup response message. At 316, the UE 110 transmits to the last serving gNB 170-2 an NAS registration complete message. At 318, the last serving gNB 170-2 transmits to the old AMF 190-1 an NGAP registration complete message. At 320, the UE 110 is in RRC CONNCTED CM-CONNECTED state. At 322, as it relates to the gNB 170-1 (e.g. a TN gNB 170-1), the last serving gNB 170-2, and the old AMF 190-1, the gNB 170-1 (PLMN 1) and gNB 170-2 (PLMN 2) have Xn connectivity, the gNB 170-2 and gNB 170-1 are 5G NR RATs, and PLMN 1 and PLMN2 may be configured as EPLMNs. At 324, the last serving gNB 170-2 transmits to the UE 110 an RRC Release message (with SuspendConfig). At 326, the UE 110 is in RRC_INACTIVE CM-CONNECTED state. At 328, related to the UE 110 and the gNB 170-1, the UE 110 re-selects to a network cell (e.g. a TN network cell to which gNB 170-1 provides access).

At 330, the UE 110 transmits an RRCResumeRequest message (new cause) to the gNB 170-1. At 332, the gNB 170-1 transmits to the last serving gNB 170-2 a retrieve UE context request (RNAU) message. At 334, the last serving gNB 170-2 transmits to the gNB 170-1 a retrieve UE context response message. At 335, the gNB 170-1 stores the new cause in the Resume Request and retains the UE 110 in RRC_INACTIVE state with updated suspendConfig. At 336, the gNB 170-1 transmits to the UE 110 a UL grant. At 338, the gNB 170-1 transmits to the UE 110 an RRCRelease message with updated suspend config. At 340, the UE 110 is in RRC_INACTIVE CM-CONNECTED state. At 342, the gNB 170-1 based on the earlier stored cause treats the subsequent SDT message content as NAS and initiates a path switch procedure. At 344, the UE 110 transmits to the gNB 170-1 a PUSCH transmission including a “Registration Request NAS message”.

At 346, the gNB 170-1 transmits to the last serving gNB 170-2 a data forwarding address indication. At 348, the gNB 170-1 transmits to the new AMF 190-2 a path switch request. At 350, the new AMF 190-1 transmits to the gNB 170-1 a path switch request response. At 352, the gNB 170-1 transmits to the last serving gNB 170-2 a UE context release message. At 354, the gNB 170-1 transmits to the new AMF 190-2 an NGAP uplink NAS transport (registration request (mobility update)) message. At 356, the UE context transfer from the old AMF 190-1 to the new AMF 190-2 on receiving the registration request happens as per the legacy procedures. At 358, related to the old AMF 190-1 and the new AMF 190-2, the UE 110 is in RRC_INACTIVE state inter-PLMN connection resume while retaining the PDU session and DRBs setup before moving the UE 110 to RRC_INACTIVE state, thus avoiding RRC_Reestablishment. At 360, the new AMF 190-2 transmits to the gNB 170-1 an NGAP downlink NAS transport (registration accept) message. At 362, the gNB 170-1 transmits to the UE 110 a PDSCH transmission including a “registration accept” message.

The signaling diagram for an alternate embodiment is shown in FIG. 4. Key aspects include those shown at item 414 (“In case gNB is preconfigured with the PLMN list that supports inter-PLMN RRC_INACTIVE state mobility”), item 416 (“serving network may broadcast the support of inter-PLMN connection resume in the serving cell either in SIB1 or network specific SIB19 or any other SIB”), item 428 (“inter-PLMN RRC_INACTIVE state_mobility_enable+PLMN list”), item 434 (“(New cause)”), item 446 (“UE in RRC_INACTIVE CM-CONNECTED”), item 448 (“gNB based on the earlier stored cause treats the subsequent SDT message content as NAS and initiates PATH SWITCH PROCEDURE”), item 464 (“UE RRC_INACTIVE state inter-PLMN connection resume while retaining the PDU sessions and DRBs setup before moving the UE to RRC_INACTIVE state, thus avoiding RRC_Reestablishment”), and item 468 (“(“Registration Accept”)”).

At 402, the UE 110 transmits an RRC setup request to the last serving gNB 170-2 (e.g. an NTN gNB 170-2). Last serving gNB 170-2 may also be referred to as a serving network node, which becomes a last serving network node following the UE 110 reselecting to another cell to which another network node (e.g. gNB 170-1) provides access. At 404, the last serving gNB 170-2 transmits to the UE 110 an RRC setup message. At 406, the UE 110 transmits to the last serving gNB 170-2 an RRC setup complete and NAS registration message. At 408, the last serving gNB 170-2 transmits to the old AMF 190-1 an NGAP initial UE message and registration request. At 410, the old AMF 190-1 transmits to the last serving gNB 170-2 an NGAP initial context setup request and registration accept message. At 412, the last serving gNB 170-2 transmits to the UE 110 an RRC connection reconfiguration SRB2, DRB and registration accept message. At 414, as performed with the last serving gNB 170-2, in case the gNB 170-2 is preconfigured with the PLMN list that supports inter-PLMN RRC_INACTIVE state mobility, then at 416 the serving network may broadcast the support of inter_PLMN connection resume in the serving cell either in SIB1 or a network (e.g. NTN) specific SIB19 or any other SIB.

At 418, the last serving gNB 170-2 transmits to the old AMF 190-1 an NGAP initial context setup response message. At 420, the UE 110 transmits to the last serving gNB 170-2 an NAS registration complete message. At 422, the last serving gNB 170-2 transmits to the old AMF 190-1 an NGAP registration complete message. At 424, the UE 110 is in RRC CONNCTED CM-CONNECTED state. At 426, as it relates to the gNB 170-1 (e.g. a TN gNB 170-1), the last serving gNB 170-2, and the old AMF 190-1, the gNB 170-1 (PLMN 1) and gNB 170-2 (PLMN 2) have Xn connectivity. The gNB 170-2 and gNB 170-1 are 5G NR RATs. PLMN 1 and PLMN2 may be configured as EPLMNs. At 428, the last serving gNB 170-2 transmits to the UE 110 an RRC Release message (with SuspendConfig and inter-PLMN RRC INATIVE state_mobility_enable and the PLMN list). At 430, the UE 110 is in RRC_INACTIVE CM-CONNECTED state. At 432, related to the UE 110 and the gNB 170-1 (e.g. a TN gNB 170-1), the UE 110 re-selects to a network cell (e.g. a TN network cell or a network cell to which gNB 170-1 provides access).

At 434, the UE 110 transmits an RRCResumeRequest message (new cause) to the gNB 170-1. At 436, the gNB 170-1 transmits to the last serving gNB 170-2 a retrieve UE context request (RNAU) message. At 438, the last serving gNB 170-2 transmits to the gNB 170-1 a retrieve UE context response message. At 440, the gNB 170-1 stores the new cause in the resume request and retains the UE 110 in RRC_INACTIVE state with updated suspendConfig. At 442, the gNB 170-1 transmits to the UE 110 a UL grant. At 444, the gNB 170-1 transmits to the UE 110 an RRCRelease message with updated suspend config. At 446, the UE 110 is in RRC_INACTIVE CM-CONNECTED state. At 448, the gNB 170-1 based on the earlier stored cause treats the subsequent SDT message content as NAS and initiates a path switch procedure. At 450, the UE 110 transmits to the gNB 170-1 a PUSCH transmission including a “Registration Request NAS message”.

At 452, the GNB 170-1 transmits to the last serving GNB 170-2 a data forwarding address indication. At 454, the gNB 170-1 transmits to the new AMF 190-2 a path switch request. At 456, the new AMF 190-1 transmits to the gNB 170-1 a path switch request response. At 458, the gNB 170-1 transmits to the last serving gNB 170-2 a UE context release message. At 460, the gNB 170-1 transmits to the new AMF 190-2 an NGAP uplink NAS transport (registration request (mobility update)) message. At 462, the UE context transfer from the old AMF 190-1 to the new AMF 190-2 on receiving the registration request happens as per the legacy procedures. At 464, related to the old AMF 190-1 and the new AMF 190-2, the UE 110 is in RRC_INACTIVE state inter-PLMN connection resume while retaining the PDU session and DRBs setup before moving the UE 110 to RRC_INACTIVE state, thus avoiding RRC_Reestablishment. At 466, the new AMF 190-2 transmits to the gNB 170-1 an NGAP downlink NAS transport (registration accept) message. At 468, the gNB 170-1 transmits to the UE 110 a PDSCH transmission including a “registration accept” message.

There are several advantages and technical effects of the examples described herein. The examples described herein enable inter-PLMN connection resume between networks and network nodes, such as NTN and TN, with NTN and TN configured in different CN registration areas. Inter-PLMN cell reselection for a UE in RRC_INACTIVE state is performed without transition to RRC_IDLE and/or RRC_CONNECTED. The methods described herein allow a UE to perform a mobility registration update in RRC_INACTIVE state without RRC state transition, thus reducing signaling overhead, latency and UE and network power consumption. The methods described herein enable preservation of the PDU sessions/DRBs associated with the UE and the necessity to have to re-establish them all due to a transition via RRC_IDLE. The methods described herein enables graceful service continuity and network re-selection without RRC connection release or unwanted transition to RRC_CONNECTED state or to RRC_IDLE. The methods described herein provides additional criteria for cell re-selection in RRC_INACTIVE state.

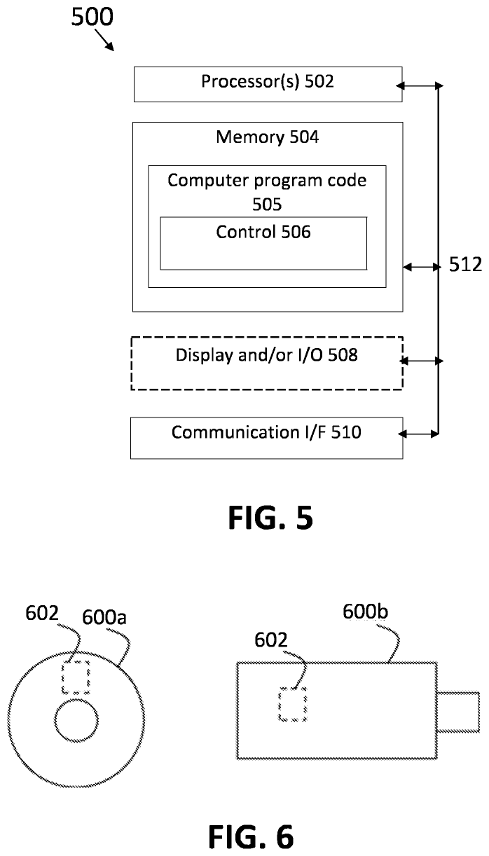

FIG. 5 is an example apparatus 500, which may be implemented in hardware, configured to implement the examples described herein. The apparatus 500 comprises at least one processor 502 (e.g. an FPGA and/or CPU), at least one memory 504 including computer program code 505, wherein the at least one memory 504 and the computer program code 505 are configured to, with the at least one processor 502, cause the apparatus 500 to implement circuitry, a process, component, module, or function (collectively control 506) to implement the examples described herein, including multiple random access responses. The memory 504 may be a non-transitory memory, a transitory memory, a volatile memory (e.g. RAM), or a non-volatile memory (e.g. ROM).

The apparatus 500 optionally includes a display and/or I/O interface 508 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique. The communication I/F(s) 510 may comprise one or more transmitters and one or more receivers. The communication I/F(s) 510 may comprise standard well-known components such as an amplifier, filter, frequency-converter, (de)modulator, and encoder/decoder circuitries and one or more antennas.

The apparatus 500 to implement the functionality of control 506 may be UE 110, RAN node 170 (e.g. gNB), or network element(s) 190. Thus, processor 502 may correspond to processor(s) 120, processor(s) 152 and/or processor(s) 175, memory 504 may correspond to memory(ies) 125, memory(ies) 155 and/or memory(ies) 171, computer program code 505 may correspond to computer program code 123, module 140-1, module 140-2, and/or computer program code 153, module 150-1, module 150-2, and/or computer program code 173, and communication I/F(s) 510 may correspond to transceiver 130, antenna(s) 128, transceiver 160, antenna(s) 158, N/W I/F(s) 161, and/or N/W I/F(s) 180. Alternatively, apparatus 500 may not correspond to either of UE 110, RAN node 170, or network element(s) 190, as apparatus 500 may be part of a self-organizing/optimizing network (SON) node, such as in a cloud.

The apparatus 500 may also be distributed throughout the network (e.g. 100) including within and between apparatus 500 and any network node or network element e.g., (such as a network control element (NCE) 190 and/or the RAN node 170 and/or the UE 110).

Interface 512 enables data communication between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code 505, including control 506 may comprise object-oriented software configured to pass data or messages between objects within computer program code 505. The apparatus 500 need not comprise each of the features mentioned, or may comprise other features as well.

FIG. 6 shows a schematic representation of non-volatile memory media 600a (e.g. computer disc (CD) or digital versatile disc (DVD)) and 600b (e.g. universal serial bus (USB) memory stick) storing instructions and/or parameters 602 which when executed by a processor allows the processor to perform one or more of the steps of the methods described herein.

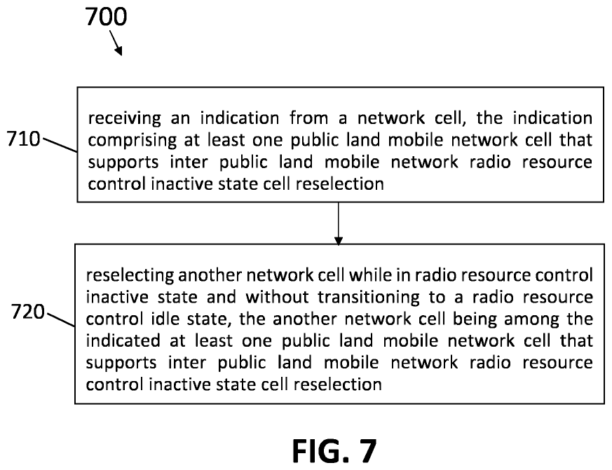

FIG. 7 is an example method 700 to implement the example embodiments described herein. At 710, the method includes receiving an indication from a network cell, the indication comprising at least one public land mobile network cell that supports inter public land mobile network radio resource control inactive state cell reselection. At 720, the method includes reselecting another network cell while in radio resource control inactive state and without transitioning to a radio resource control idle state, the another network cell being among the indicated at least one public land mobile network cell that supports inter public land mobile network radio resource control inactive state cell reselection. Method 700 may be implemented with UE 110 or apparatus 500.

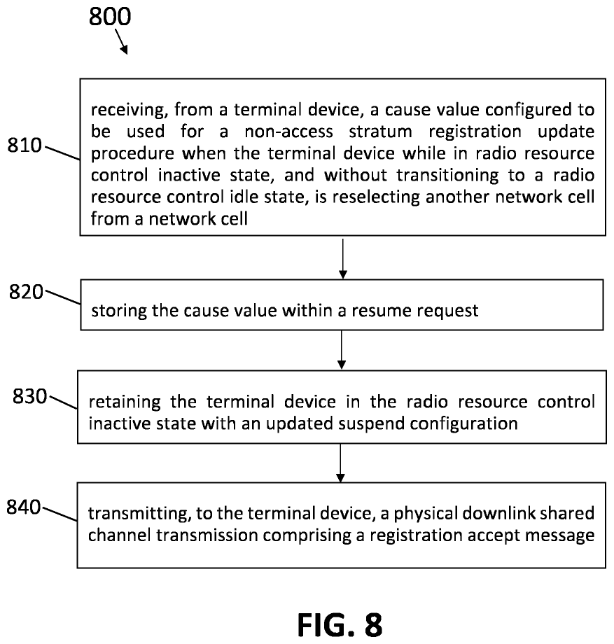

FIG. 8 is an example method 800 to implement the example embodiments described herein. At 810, the method includes receiving, from a terminal device, a cause value configured to be used for a non-access stratum registration update procedure when the terminal device while in radio resource control inactive state, and without transitioning to a radio resource control idle state, is reselecting another network cell from a network cell. At 820, the method includes storing the cause value within a resume request. At 830, the method includes retaining the terminal device in the radio resource control inactive state with an updated suspend configuration. At 840, the method includes transmitting, to the terminal device, a physical downlink shared channel transmission comprising a registration accept message. Method 800 may be implemented with RAN node 170, network node 170-1, network node 170-2, or apparatus 500.

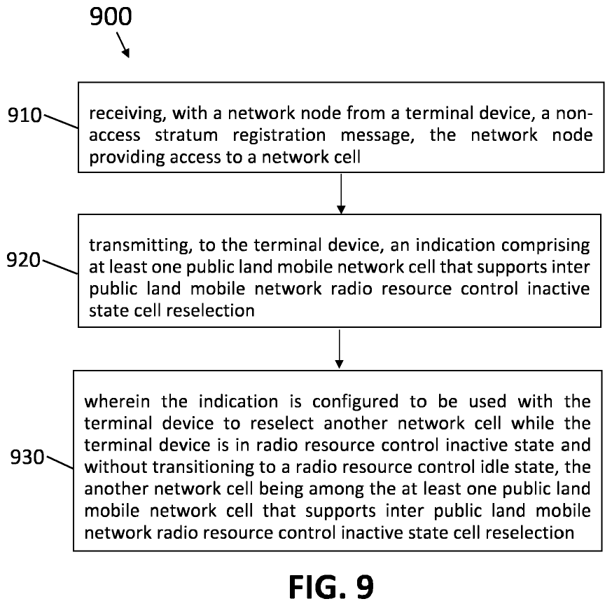

FIG. 9 is an example method 900 implementing the examples described herein. At 910, the method includes receiving, with a network node from a terminal device, a non-access stratum registration message, the network node providing access to a network cell. At 920, the method includes transmitting, to the terminal device, an indication comprising at least one public land mobile network cell that supports inter public land mobile network radio resource control inactive state cell reselection. At 930, the method includes wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection. Method 900 may be implemented with RAN node 170, network node 170-1, network node 170-2, or apparatus 500.

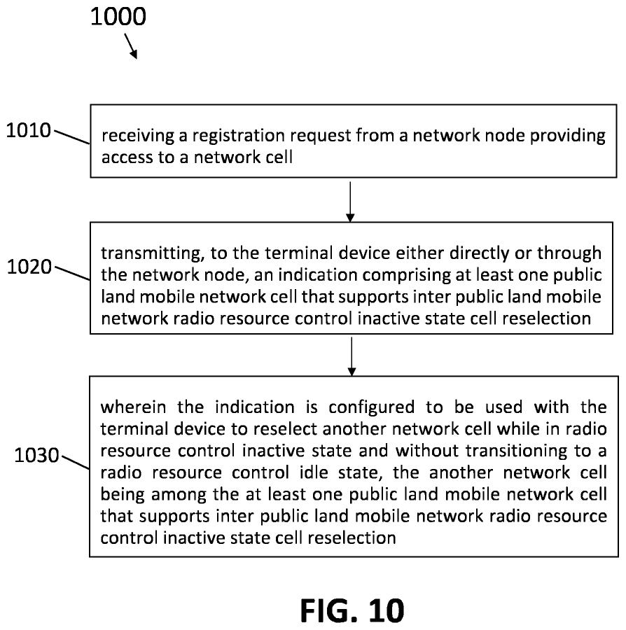

FIG. 10 is an example method 1000 implementing the examples described herein. At 1010, the method includes receiving a registration request from a network node providing access to a network cell. At 1020, the method includes transmitting, to the terminal device either directly or through the network node, an indication comprising at least one public land mobile network cell that supports inter public land mobile network radio resource control inactive state cell reselection. At 1030, the method includes wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection. Method 1000 may be performed with network element 190, network element 190-1, or apparatus 500.

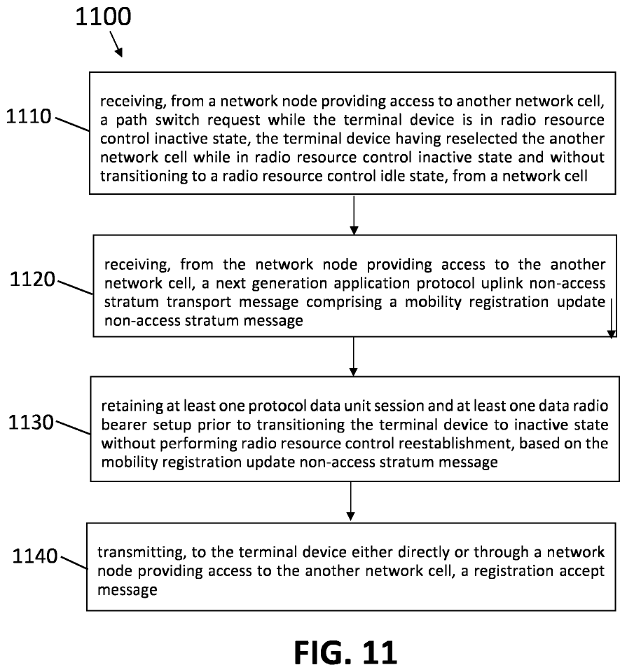

FIG. 11 is an example method 1100 implementing the examples described herein. At 1110, the method includes receiving, from a network node providing access to another network cell, a path switch request while the terminal device is in radio resource control inactive state, the terminal device having reselected the another network cell while in radio resource control inactive state and without transitioning to a radio resource control idle state, from a network cell. At 1120, the method includes receiving, from the network node providing access to the another network cell, a next generation application protocol uplink non-access stratum transport message comprising a mobility registration update non-access stratum message. At 1130, the method includes retaining at least one protocol data unit session and at least one data radio bearer setup prior to transitioning the terminal device to inactive state without performing radio resource control reestablishment, based on the mobility registration update non-access stratum message. At 1140, the method includes transmitting, to the terminal device either directly or through a network node providing access to the another network cell, a registration accept message. Method 1100 may be performed with network element 190, network element 190-2, or apparatus 500.

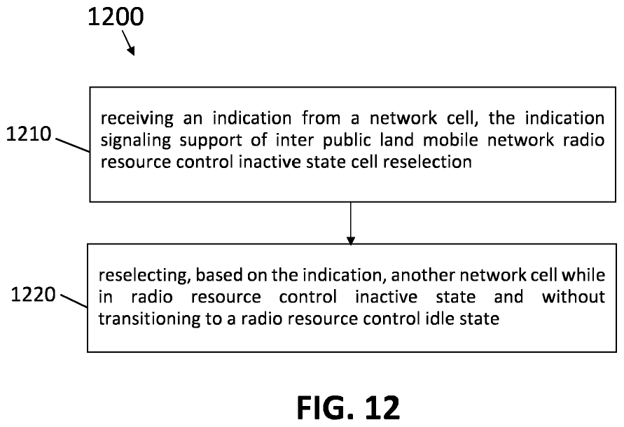

FIG. 12 is an example method 1200 implementing the examples described herein. At 1210, the method includes receiving an indication from a network cell, the indication signaling support of inter public land mobile network radio resource control inactive state cell reselection. At 1220, the method includes reselecting, based on the indication, another network cell while in radio resource control inactive state and without transitioning to a radio resource control idle state. Method 1200 may be implemented with UE 110 or apparatus 500.

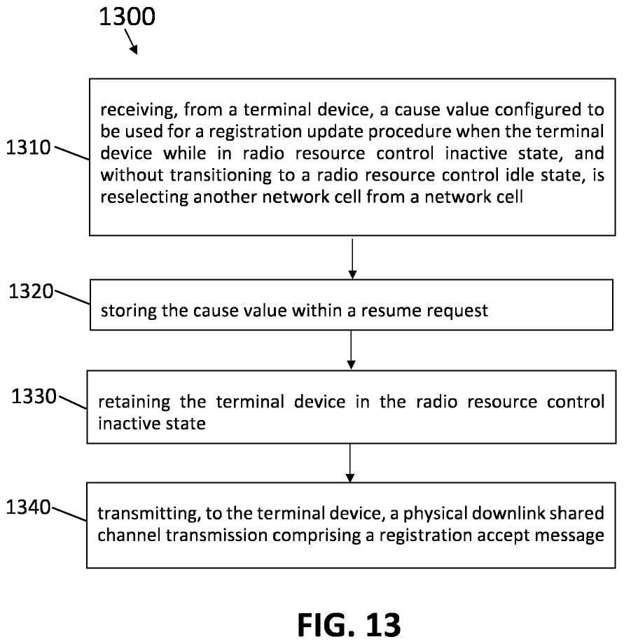

FIG. 13 is an example method 1300 implementing the examples described herein. At 1310, the method includes receiving, from a terminal device, a cause value configured to be used for a registration update procedure when the terminal device while in radio resource control inactive state, and without transitioning to a radio resource control idle state, is reselecting another network cell from a network cell. At 1320, the method includes storing the cause value within a resume request. At 1330, the method includes retaining the terminal device in the radio resource control inactive state. At 1340, the method includes transmitting, to the terminal device, a physical downlink shared channel transmission comprising a registration accept message. Method 1300 may be implemented with RAN node 170, network node 170-1, network node 170-2, or apparatus 500.

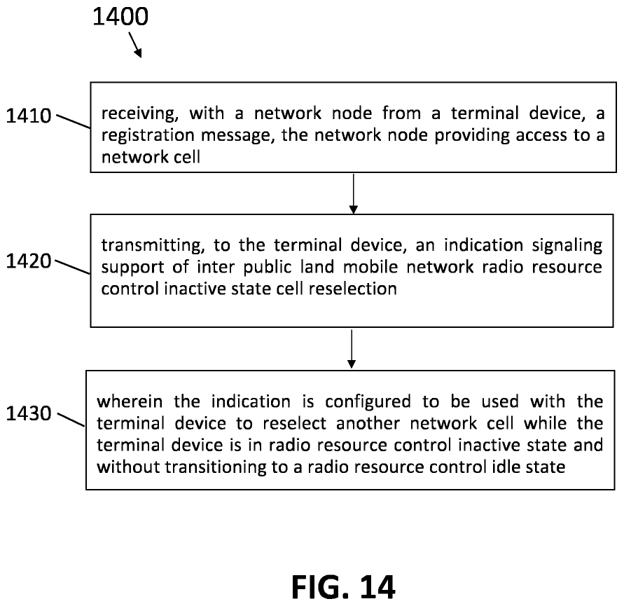

FIG. 14 is an example method 1400 implementing the examples described herein. At 1410, the method includes receiving, with a network node from a terminal device, a registration message, the network node providing access to a network cell. At 1420, the method includes transmitting, to the terminal device, an indication signaling support of inter public land mobile network radio resource control inactive state cell reselection. At 1430, the method includes wherein the indication is configured to be used with the terminal device to reselect another network cell while the terminal device is in radio resource control inactive state and without transitioning to a radio resource control idle state. Method 1400 may be implemented with RAN node 170, network node 170-1, network node 170-2, or apparatus 500.

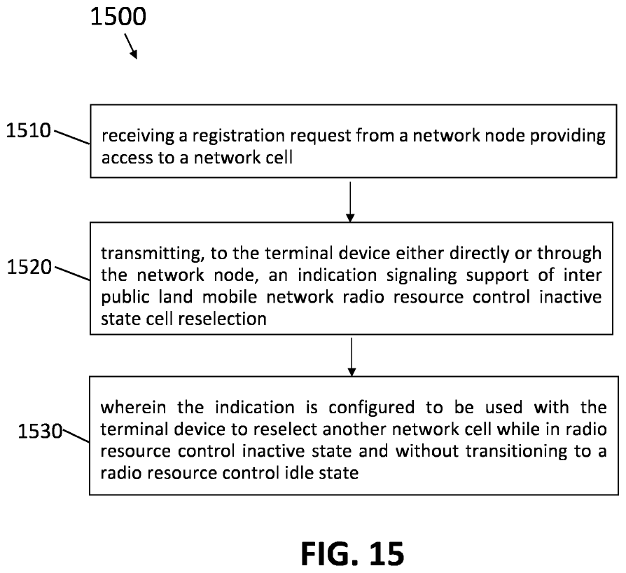

FIG. 15 is an example method 1500 implementing the examples described herein. At 1510, the method includes receiving a registration request from a network node providing access to a network cell. At 1520, the method includes transmitting, to the terminal device either directly or through the network node, an indication signaling support of inter public land mobile network radio resource control inactive state cell reselection. At 1530, the method includes wherein the indication is configured to be used with the terminal device to reselect another network cell while in radio resource control inactive state and without transitioning to a radio resource control idle state. Method 1500 may be performed with network element 190, network element 190-1, or apparatus 500.

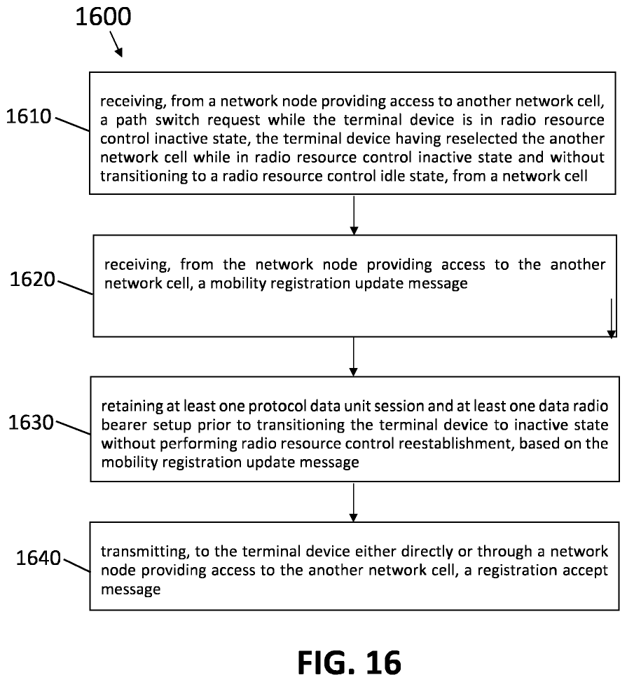

FIG. 16 is an example method 1600 implementing the examples described herein. At 1610, the method includes receiving, from a network node providing access to another network cell, a path switch request while the terminal device is in radio resource control inactive state, the terminal device having reselected the another network cell while in radio resource control inactive state and without transitioning to a radio resource control idle state, from a network cell. At 1620, the method includes receiving, from the network node providing access to the another network cell, a mobility registration update message; retaining at least one protocol data unit session and at least one data radio bearer setup prior to transitioning the terminal device to inactive state without performing radio resource control reestablishment, based on the mobility registration update message. At 1630, the method includes transmitting, to the terminal device either directly or through a network node providing access to the another network cell, a registration accept message. Method 1600 may be performed with network element 190, network element 190-2, or apparatus 500.

The following examples are described and provided herein.

Example 1. An apparatus, including: at least one processor; and at least one memory storing instructions that, when executed by the at least one processor, cause the apparatus at least to: receive an indication from a network cell, the indication comprising at least one public land mobile network cell that supports inter public land mobile network radio resource control inactive state cell reselection; and reselect another network cell while in radio resource control inactive state and without transitioning to a radio resource control idle state, the another network cell being among the indicated at least one public land mobile network cell that supports inter public land mobile network radio resource control inactive state cell reselection.

Example 2. The apparatus of example 1, wherein the apparatus comprises a terminal device or a user equipment.

Example 3. The apparatus of any of examples 1 to 2, wherein the instructions, when executed by the at least one processor, cause the apparatus at least to: reselect the another network cell without transitioning to a radio resource control connected state.

Example 4. The apparatus of any of examples 1 to 3, wherein the instructions, when executed by the at least one processor, cause the apparatus at least to: receive the indication from an access and mobility management function of a core network through the network cell.

Example 5. The apparatus of any of examples 1 to 4, wherein the instructions, when executed by the at least one processor, cause the apparatus at least to: receive the indication while in radio resource control inactive state.

Example 6. The apparatus of example 5, wherein the instructions, when executed by the at least one processor, cause the apparatus at least to: receive the indication within a system information block message.

Example 7. The apparatus of any of examples 1 to 6, wherein the instructions, when executed by the at least one processor, cause the apparatus at least to: receive the indication from a serving network node providing access to the network cell, where the network cell comprises a non-terrestrial network cell or a terrestrial network cell.

Example 8. The apparatus of example 7, wherein the instructions, when executed by the at least one processor, cause the apparatus at least to: receive, while in radio resource control connected state, the indication from the serving network node before transitioning to the radio resource control inactive state.

Example 9. The apparatus of any of examples 7 to 8, wherein the serving network node becomes a last serving network node following the reselection of the another network cell while the terminal device is in radio resource control inactive state.

Example 10. The apparatus of any of examples 7 to 9, wherein the instructions, when executed by the at least one processor, cause the apparatus at least to: receive the indication from the serving network node providing access to the network cell as part of a registration accept message.

Example 11. The apparatus of any of examples 7 to 10, wherein the instructions, when executed by the at least one processor, cause the apparatus at least to: receive the indication from the serving network node providing access to the network cell as part of a radio resource control release message with a suspend configuration.

Example 12. The apparatus of any of examples 7 to 11, wherein the instructions, when executed by the at least one processor, cause the apparatus at least to: receive the indication from the serving network node providing access to the network cell as part of broadcast signaling.

Example 13. The apparatus of example 12, wherein the broadcast signaling comprises one of: a system information block type 1 message, or a network specific system information block type 19 message.

Example 14. The apparatus of any of examples 1 to 13, wherein the instructions, when executed by the at least one processor, cause the apparatus at least to: receive the indication with dedicated signaling, the dedicated signaling comprising a radio resource control connection reconfiguration message.

Example 15. The apparatus of any of examples 1 to 14, wherein the instructions, when executed by the at least one processor, cause the apparatus at least to: transmit a cause value to a network node providing access to the another network cell, when the network node providing access to the another network cell is different from a serving network node providing access to the network cell.

Example 16. The apparatus of example 15, wherein the cause value is configured to be used for a non-access stratum registration update procedure.

Example 17. The apparatus of any of examples 15 to 16, wherein the instructions, when executed by the at least one processor, cause the apparatus at least to: transmit the cause value within a radio resource control resume request message.

Example 18. The apparatus of example 17, wherein the instructions, when executed by the at least one processor, cause the apparatus at least to: transmit the cause value within the radio resource control resume request message using a dedicated logical channel identifier. Example 19. The apparatus of any of examples 1 to 18, wherein the instructions, when executed by the at least one processor, cause the apparatus at least to: initiate, with a network node providing access to the another network cell, a small data transmission procedure for a mobility registration update while in the radio resource control inactive state.

Example 20. The apparatus of example 19, wherein the instructions, when executed by the at least one processor, cause the apparatus at least to: transmit, to the network node providing access to the another network cell during the mobility registration update, a registration request with mobility update non-access stratum message as a message 3 of a 4-step random access channel procedure, based on the message 3 being of a size sufficient to accommodate the non-access stratum message; and transmit, to the network node providing access to the another network cell, a buffer status report in the message 3 requesting an additional uplink grant, based on the message 3 not being of a size sufficient to accommodate the non-access stratum message.

Example 21. The apparatus of any of examples 19 to 20, wherein the instructions, when executed by the at least one processor, cause the apparatus at least to: indicate, to the network node providing access to the another network cell during the mobility registration update, a size for message 3 of a 4-step random access channel procedure for accommodating a registration request with mobility update non-access stratum message.

Example 22. The apparatus of any of examples 1 to 21, wherein the at least one public land mobile network cell that supports inter public land mobile network radio resource control inactive state cell reselection is received within a list.

Example 23. The apparatus of any of examples 1 to 22, wherein the instructions, when executed by the at least one processor, cause the apparatus at least to: receive, with a physical downlink shared channel transmission, a registration accept message from a network node providing access to the another network cell.

Example 24. The apparatus of any of examples 1 to 23, wherein the instructions, when executed by the at least one processor, cause the apparatus at least to: receive a registration accept message from an access and mobility management function, based on the reselection to the another network cell while in radio resource control inactive state.

Example 25. The apparatus of any of examples 1 to 24, wherein the network cell comprises a non-terrestrial network cell, and the another network cell comprises a terrestrial network cell.

Example 26. The apparatus of any of examples 1 to 25, wherein the network cell comprises a terrestrial network cell, and the another network cell comprises a non-terrestrial network cell.

Example 27. The apparatus of any of examples 1 to 26, wherein the network cell comprises a non-terrestrial network cell, and the another network cell comprises a non-terrestrial network cell.

Example 28. The apparatus of any of examples 1 to 27, wherein the network cell comprises a terrestrial network cell, and the another network cell comprises a terrestrial network cell.

Example 29. An apparatus, including: at least one processor; and at least one memory storing instructions that, when executed by the at least one processor, cause the apparatus at least to: receive, from a terminal device, a cause value configured to be used for a non-access stratum registration update procedure when the terminal device while in radio resource control inactive state, and without transitioning to a radio resource control idle state, is reselecting another network cell from a network cell; store the cause value within a resume request; retain the terminal device in the radio resource control inactive state with an updated suspend configuration; and transmit, to the terminal device, a physical downlink shared channel transmission comprising a registration accept message.

Example 30. The apparatus of example 29, wherein: a network node providing access to the another network cell is different from a network node providing access to the network cell, the apparatus comprises the network node providing access to the another network cell, and the network node providing access to the network cell becomes a last serving network node following the reselection of the another network cell while the terminal device is in radio resource control inactive state.

Example 31. The apparatus of any of examples 29 to 30, wherein the instructions, when executed by the at least one processor, cause the apparatus at least to: receive, from a terminal device during a small data transmission procedure, a mobility registration update non-access stratum message; initiate a path switch procedure with an access and mobility management function, based on the stored cause while retaining the terminal device in radio resource control inactive state; and transmit, to the access and mobility management function, a next generation application protocol uplink non-access stratum transport message comprising the mobility registration update non-access stratum message, while retaining the terminal device in radio resource control inactive state.

Example 32. An apparatus, including: at least one processor; and at least one memory storing instructions that, when executed by the at least one processor, cause the apparatus at least to: receive, with a network node from a terminal device, a non-access stratum registration message, the network node providing access to a network cell; and transmit, to the terminal device, an indication comprising at least one public land mobile network cell that supports inter public land mobile network radio resource control inactive state cell reselection; wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

Example 33. The apparatus of example 32, wherein the instructions, when executed by the at least one processor, cause the apparatus at least to: receive, from an access and mobility management function, an initial indication comprising the at least one public land mobile network cell that supports inter public land mobile network radio resource control inactive state cell reselection; wherein the indication transmitted to the terminal device comprises the initial indication received from the access and mobility management function.

Example 34. The apparatus of any of examples 32 to 33, wherein the apparatus comprises the network node, and the network node becomes a last serving network node following the reselection of the another network cell while the terminal device is in radio resource control inactive state.

Example 35. The apparatus of any of examples 32 to 34, wherein the instructions, when executed by the at least one processor, cause the apparatus at least to perform at least one of: transmit the indication from the network node providing access to the network cell as part of a registration accept message; transmit the indication from the network node providing access to the network cell as part of a radio resource control release message with a suspend configuration; transmit the indication with broadcast signaling; or transmit the indication with dedicated signaling, the dedicated signaling comprising a radio resource control connection reconfiguration message.

Example 36. The apparatus of example 35, wherein the broadcast signaling comprises one of: a system information block type 1 message, or a network specific system information block type 19 message.

Example 37. The apparatus of any of examples 32 to 36, wherein the instructions, when executed by the at least one processor, cause the apparatus at least to: transmit the indication while the terminal device is in radio resource control inactive state.

Example 38. The apparatus of example 37, wherein the instructions, when executed by the at least one processor, cause the apparatus at least to: transmit the indication within a system information block message.

Example 39. An apparatus, including: at least one processor; and at least one memory storing instructions that, when executed by the at least one processor, cause the apparatus at least to: receive a registration request from a network node providing access to a network cell; and transmit, to the terminal device either directly or through the network node, an indication comprising at least one public land mobile network cell that supports inter public land mobile network radio resource control inactive state cell reselection; wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection.

Example 40. The apparatus of example 39, at least one memory storing instructions that, when executed by the at least one processor, cause the apparatus at least to: retain at least one protocol data unit session and at least one data radio bearer setup prior to transitioning the terminal device to inactive state without performing radio resource control reestablishment.

Example 41. The apparatus of any of examples 39 to 40, wherein the instructions, when executed by the at least one processor, cause the apparatus at least to: transmit the indication while the terminal device is in radio resource control inactive state.

Example 42. The apparatus of example 41, wherein the instructions, when executed by the at least one processor, cause the apparatus at least to: transmit the indication within a system information block message.

Example 43. An apparatus, including: at least one processor; and at least one memory storing instructions that, when executed by the at least one processor, cause the apparatus at least to: receive, from a network node providing access to another network cell, a path switch request while the terminal device is in radio resource control inactive state, the terminal device having reselected the another network cell while in radio resource control inactive state and without transitioning to a radio resource control idle state, from a network cell; receive, from the network node providing access to the another network cell, a next generation application protocol uplink non-access stratum transport message comprising a mobility registration update non-access stratum message; retain at least one protocol data unit session and at least one data radio bearer setup prior to transitioning the terminal device to inactive state without performing radio resource control reestablishment, based on the mobility registration update non-access stratum message; and transmit, to the terminal device either directly or through a network node providing access to the another network cell, a registration accept message.

Example 44. The apparatus of example 43, at least one memory storing instructions that, when executed by the at least one processor, cause the apparatus at least to: perform a context transfer from a previous access and mobility management function to a new access and mobility management function.

Example 45. An apparatus, including: at least one processor; and at least one memory storing instructions that, when executed by the at least one processor, cause the apparatus at least to: receive an indication from a network cell, the indication signaling support of inter public land mobile network radio resource control inactive state cell reselection; and reselect, based on the indication, another network cell while in radio resource control inactive state and without transitioning to a radio resource control idle state.

Example 46. The apparatus of example 45, wherein the indication comprises at least one public land mobile network cell that supports inter public land mobile network radio resource control inactive state cell reselection.

Example 47. The apparatus of example 46, wherein the another network cell is among at least one public land mobile network cell that supports inter public land mobile network radio resource control inactive state cell reselection.

Example 48. The apparatus of any of examples 45 to 47, wherein the instructions, when executed by the at least one processor, cause the apparatus at least to: receive the indication while in radio resource control inactive state.

Example 49. The apparatus of example 48, wherein the instructions, when executed by the at least one processor, cause the apparatus at least to: receive the indication within a system information block message.

Example 50. An apparatus, including: at least one processor; and at least one memory storing instructions that, when executed by the at least one processor, cause the apparatus at least to: receive, from a terminal device, a cause value configured to be used for a registration update procedure when the terminal device while in radio resource control inactive state, and without transitioning to a radio resource control idle state, is reselecting another network cell from a network cell; store the cause value within a resume request; retain the terminal device in the radio resource control inactive state; and transmit, to the terminal device, a physical downlink shared channel transmission comprising a registration accept message.

Example 51. The apparatus of example 50, wherein the registration update procedure comprises a non-access stratum registration update procedure.

Example 52. The apparatus of any of examples 50 to 51, wherein the instructions, when executed by the at least one processor, cause the apparatus at least to: retain the terminal device in the radio resource control inactive state with an updated suspend configuration.

Example 53. An apparatus, including: at least one processor; and at least one memory storing instructions that, when executed by the at least one processor, cause the apparatus at least to: receive, with a network node from a terminal device, a registration message, the network node providing access to a network cell; and transmit, to the terminal device, an indication signaling support of inter public land mobile network radio resource control inactive state cell reselection; wherein the indication is configured to be used with the terminal device to reselect another network cell while the terminal device is in radio resource control inactive state and without transitioning to a radio resource control idle state.

Example 54. The apparatus of example 53, wherein the registration message comprises a non-access stratum registration message.

Example 55. The apparatus of any of examples 53 to 54, wherein the indication comprises at least one public land mobile network cell that supports inter public land mobile network radio resource control inactive state cell reselection.

Example 56. The apparatus of example 55, wherein the another network cell is among the at least one public land mobile network cell that supports inter public land mobile network radio resource control inactive state cell reselection.

Example 57. The apparatus of any of examples 53 to 56, wherein the instructions, when executed by the at least one processor, cause the apparatus at least to: transmit the indication while the terminal device is in radio resource control inactive state.

Example 58 The apparatus of example 57, wherein the instructions, when executed by the at least one processor, cause the apparatus at least to: transmit the indication within a system information block message.

Example 59. An apparatus, including: at least one processor; and at least one memory storing instructions that, when executed by the at least one processor, cause the apparatus at least to: receive a registration request from a network node providing access to a network cell; and transmit, to the terminal device either directly or through the network node, an indication signaling support of inter public land mobile network radio resource control inactive state cell reselection; wherein the indication is configured to be used with the terminal device to reselect another network cell while in radio resource control inactive state and without transitioning to a radio resource control idle state.

Example 60. The apparatus of example 59, wherein the indication comprises at least one public land mobile network cell that supports inter public land mobile network radio resource control inactive state cell reselection.

Example 61. The apparatus of example 60, wherein the another network cell is among the at least one public land mobile network cell that supports inter public land mobile network radio resource control inactive state cell reselection.

Example 62. The apparatus of any of examples 59 to 61, wherein the instructions, when executed by the at least one processor, cause the apparatus at least to: transmit the indication while the terminal device is in radio resource control inactive state.

Example 63. An apparatus, including: at least one processor; and at least one memory storing instructions that, when executed by the at least one processor, cause the apparatus at least to: receive, from a network node providing access to another network cell, a path switch request while the terminal device is in radio resource control inactive state, the terminal device having reselected the another network cell while in radio resource control inactive state and without transitioning to a radio resource control idle state, from a network cell; receive, from the network node providing access to the another network cell, a mobility registration update message; retain at least one protocol data unit session and at least one data radio bearer setup prior to transitioning the terminal device to inactive state without performing radio resource control reestablishment, based on the mobility registration update message; and transmit, to the terminal device either directly or through a network node providing access to the another network cell, a registration accept message.

Example 64. The apparatus of example 63, wherein the mobility registration update message is received as part of a next generation application protocol uplink non-access stratum transport message.

Example 65. The apparatus of any of examples 63 to 64, wherein the mobility registration update message comprises a non-access stratum message.

Example 66. A method including: receiving an indication from a network cell, the indication comprising at least one public land mobile network cell that supports inter public land mobile network radio resource control inactive state cell reselection; and reselecting another network cell while in radio resource control inactive state and without transitioning to a radio resource control idle state, the another network cell being among the indicated at least one public land mobile network cell that supports inter public land mobile network radio resource control inactive state cell reselection.

Example 67. A method including: receiving, from a terminal device, a cause value configured to be used for a non-access stratum registration update procedure when the terminal device while in radio resource control inactive state, and without transitioning to a radio resource control idle state, is reselecting another network cell from a network cell; storing the cause value within a resume request; retaining the terminal device in the radio resource control inactive state with an updated suspend configuration; and transmitting, to the terminal device, a physical downlink shared channel transmission comprising a registration accept message.

Example 68. A method including: receiving, with a network node from a terminal device, a non-access stratum registration message, the network node providing access to a network cell; and transmitting, to the terminal device, an indication comprising at least one public land mobile network cell that supports inter public land mobile network radio resource control inactive state cell reselection; wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

Example 69. A method including: receiving a registration request from a network node providing access to a network cell; and transmitting, to the terminal device either directly or through the network node, an indication comprising at least one public land mobile network cell that supports inter public land mobile network radio resource control inactive state cell reselection; wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection.

Example 70. A method including: receiving, from a network node providing access to another network cell, a path switch request while the terminal device is in radio resource control inactive state, the terminal device having reselected the another network cell while in radio resource control inactive state and without transitioning to a radio resource control idle state, from a network cell; receiving, from the network node providing access to the another network cell, a next generation application protocol uplink non-access stratum transport message comprising a mobility registration update non-access stratum message; retaining at least one protocol data unit session and at least one data radio bearer setup prior to transitioning the terminal device to inactive state without performing radio resource control reestablishment, based on the mobility registration update non-access stratum message; and transmitting, to the terminal device either directly or through a network node providing access to the another network cell, a registration accept message.

Example 71. An apparatus including: means for receiving an indication from a network cell, the indication comprising at least one public land mobile network cell that supports inter public land mobile network radio resource control inactive state cell reselection; and means for reselecting another network cell while in radio resource control inactive state and without transitioning to a radio resource control idle state, the another network cell being among the indicated at least one public land mobile network cell that supports inter public land mobile network radio resource control inactive state cell reselection.

Example 72. An apparatus including: means for receiving, from a terminal device, a cause value configured to be used for a non-access stratum registration update procedure when the terminal device while in radio resource control inactive state, and without transitioning to a radio resource control idle state, is reselecting another network cell from a network cell; means for storing the cause value within a resume request; means for retaining the terminal device in the radio resource control inactive state with an updated suspend configuration; and means for transmitting, to the terminal device, a physical downlink shared channel transmission comprising a registration accept message.

Example 73. An apparatus including: means for receiving, with a network node from a terminal device, a non-access stratum registration message, the network node providing access to a network cell; and means for transmitting, to the terminal device, an indication comprising at least one public land mobile network cell that supports inter public land mobile network radio resource control inactive state cell reselection; wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

Example 74. An apparatus including: means for receiving a registration request from a network node providing access to a network cell; and means for transmitting, to the terminal device either directly or through the network node, an indication comprising at least one public land mobile network cell that supports inter public land mobile network radio resource control inactive state cell reselection; wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection.

Example 75. An apparatus including: means for receiving, from a network node providing access to another network cell, a path switch request while the terminal device is in radio resource control inactive state, the terminal device having reselected the another network cell while in radio resource control inactive state and without transitioning to a radio resource control idle state, from a network cell; means for receiving, from the network node providing access to the another network cell, a next generation application protocol uplink non-access stratum transport message comprising a mobility registration update non-access stratum message; means for retaining at least one protocol data unit session and at least one data radio bearer setup prior to transitioning the terminal device to inactive state without performing radio resource control reestablishment, based on the mobility registration update non-access stratum message; and means for transmitting, to the terminal device either directly or through a network node providing access to the another network cell, a registration accept message.

Example 76. A non-transitory program storage device readable by a machine, tangibly embodying a program of instructions executable with the machine for performing operations, the operations including: receiving an indication from a network cell, the indication comprising at least one public land mobile network cell that supports inter public land mobile network radio resource control inactive state cell reselection; and reselecting another network cell while in radio resource control inactive state and without transitioning to a radio resource control idle state, the another network cell being among the indicated at least one public land mobile network cell that supports inter public land mobile network radio resource control inactive state cell reselection.

Example 77. A non-transitory program storage device readable by a machine, tangibly embodying a program of instructions executable with the machine for performing operations, the operations including: receiving, from a terminal device, a cause value configured to be used for a non-access stratum registration update procedure when the terminal device while in radio resource control inactive state, and without transitioning to a radio resource control idle state, is reselecting another network cell from a network cell; storing the cause value within a resume request; retaining the terminal device in the radio resource control inactive state with an updated suspend configuration; and transmitting, to the terminal device, a physical downlink shared channel transmission comprising a registration accept message.

Example 78. A non-transitory program storage device readable by a machine, tangibly embodying a program of instructions executable with the machine for performing operations, the operations including: receiving, with a network node from a terminal device, a non-access stratum registration message, the network node providing access to a network cell; and transmitting, to the terminal device, an indication comprising at least one public land mobile network cell that supports inter public land mobile network radio resource control inactive state cell reselection; wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

Example 79. A non-transitory program storage device readable by a machine, tangibly embodying a program of instructions executable with the machine for performing operations, the operations including: receiving a registration request from a network node providing access to a network cell; and transmitting, to the terminal device either directly or through the network node, an indication comprising at least one public land mobile network cell that supports inter public land mobile network radio resource control inactive state cell reselection; wherein the indication is configured to be used with the terminal device to reselect another network cell while in radio resource control inactive state and without transitioning to a radio resource control idle state, the another network cell being among the at least one public land mobile network cell that supports inter public land mobile network radio resource control inactive state cell reselection.

Example 80. A non-transitory program storage device readable by a machine, tangibly embodying a program of instructions executable with the machine for performing operations, the operations including: receiving, from a network node providing access to another network cell, a path switch request while the terminal device is in radio resource control inactive state, the terminal device having reselected the another network cell while in radio resource control inactive state and without transitioning to a radio resource control idle state, from a network cell; receiving, from the network node providing access to the another network cell, a next generation application protocol uplink non-access stratum transport message comprising a mobility registration update non-access stratum message; retaining at least one protocol data unit session and at least one data radio bearer setup prior to transitioning the terminal device to inactive state without performing radio resource control reestablishment, based on the mobility registration update non-access stratum message; and transmitting, to the terminal device either directly or through a network node providing access to the another network cell, a registration accept message.

Example 81. A method including: receiving an indication from a network cell, the indication signaling support of inter public land mobile network radio resource control inactive state cell reselection; and reselecting, based on the indication, another network cell while in radio resource control inactive state and without transitioning to a radio resource control idle state.

Example 82. A method including: receiving, from a terminal device, a cause value configured to be used for a registration update procedure when the terminal device while in radio resource control inactive state, and without transitioning to a radio resource control idle state, is reselecting another network cell from a network cell; storing the cause value within a resume request; retaining the terminal device in the radio resource control inactive state; and transmitting, to the terminal device, a physical downlink shared channel transmission comprising a registration accept message.

Example 83. A method including: receiving, with a network node from a terminal device, a registration message, the network node providing access to a network cell; and transmitting, to the terminal device, an indication signaling support of inter public land mobile network radio resource control inactive state cell reselection; wherein the indication is configured to be used with the terminal device to reselect another network cell while the terminal device is in radio resource control inactive state and without transitioning to a radio resource control idle state.

Example 84. A method including: receiving a registration request from a network node providing access to a network cell; and transmitting, to the terminal device either directly or through the network node, an indication signaling support of inter public land mobile network radio resource control inactive state cell reselection; wherein the indication is configured to be used with the terminal device to reselect another network cell while in radio resource control inactive state and without transitioning to a radio resource control idle state.

Example 85. A method including: receiving, from a network node providing access to another network cell, a path switch request while the terminal device is in radio resource control inactive state, the terminal device having reselected the another network cell while in radio resource control inactive state and without transitioning to a radio resource control idle state, from a network cell; receiving, from the network node providing access to the another network cell, a mobility registration update message; retaining at least one protocol data unit session and at least one data radio bearer setup prior to transitioning the terminal device to inactive state without performing radio resource control reestablishment, based on the mobility registration update message; and transmitting, to the terminal device either directly or through a network node providing access to the another network cell, a registration accept message.

Example 86. An apparatus including: means for receiving an indication from a network cell, the indication signaling support of inter public land mobile network radio resource control inactive state cell reselection; and means for reselecting, based on the indication, another network cell while in radio resource control inactive state and without transitioning to a radio resource control idle state.

Example 87. An apparatus including: means for receiving, from a terminal device, a cause value configured to be used for a registration update procedure when the terminal device while in radio resource control inactive state, and without transitioning to a radio resource control idle state, is reselecting another network cell from a network cell; means for storing the cause value within a resume request; means for retaining the terminal device in the radio resource control inactive state; and means for transmitting, to the terminal device, a physical downlink shared channel transmission comprising a registration accept message.

Example 88. An apparatus including: means for receiving, with a network node from a terminal device, a registration message, the network node providing access to a network cell; and means for transmitting, to the terminal device, an indication signaling support of inter public land mobile network radio resource control inactive state cell reselection; wherein the indication is configured to be used with the terminal device to reselect another network cell while the terminal device is in radio resource control inactive state and without transitioning to a radio resource control idle state.

Example 89. An apparatus including: means for receiving a registration request from a network node providing access to a network cell; and means for transmitting, to the terminal device either directly or through the network node, an indication signaling support of inter public land mobile network radio resource control inactive state cell reselection; wherein the indication is configured to be used with the terminal device to reselect another network cell while in radio resource control inactive state and without transitioning to a radio resource control idle state.

Example 90. An apparatus including: means for receiving, from a network node providing access to another network cell, a path switch request while the terminal device is in radio resource control inactive state, the terminal device having reselected the another network cell while in radio resource control inactive state and without transitioning to a radio resource control idle state, from a network cell; means for receiving, from the network node providing access to the another network cell, a mobility registration update message; means for retaining at least one protocol data unit session and at least one data radio bearer setup prior to transitioning the terminal device to inactive state without performing radio resource control reestablishment, based on the mobility registration update message; and means for transmitting, to the terminal device either directly or through a network node providing access to the another network cell, a registration accept message.

Example 91. A non-transitory program storage device readable by a machine, tangibly embodying a program of instructions executable with the machine for performing operations, the operations including: receiving an indication from a network cell, the indication signaling support of inter public land mobile network radio resource control inactive state cell reselection; and reselecting, based on the indication, another network cell while in radio resource control inactive state and without transitioning to a radio resource control idle state.

Example 92. A non-transitory program storage device readable by a machine, tangibly embodying a program of instructions executable with the machine for performing operations, the operations including: receiving, from a terminal device, a cause value configured to be used for a registration update procedure when the terminal device while in radio resource control inactive state, and without transitioning to a radio resource control idle state, is reselecting another network cell from a network cell; storing the cause value within a resume request; retaining the terminal device in the radio resource control inactive state; and transmitting, to the terminal device, a physical downlink shared channel transmission comprising a registration accept message.

Example 93. A non-transitory program storage device readable by a machine, tangibly embodying a program of instructions executable with the machine for performing operations, the operations including: receiving, with a network node from a terminal device, a registration message, the network node providing access to a network cell; and transmitting, to the terminal device, an indication signaling support of inter public land mobile network radio resource control inactive state cell reselection; wherein the indication is configured to be used with the terminal device to reselect another network cell while the terminal device is in radio resource control inactive state and without transitioning to a radio resource control idle state.

Example 94. A non-transitory program storage device readable by a machine, tangibly embodying a program of instructions executable with the machine for performing operations, the operations including: receiving a registration request from a network node providing access to a network cell; and transmitting, to the terminal device either directly or through the network node, an indication signaling support of inter public land mobile network radio resource control inactive state cell reselection; wherein the indication is configured to be used with the terminal device to reselect another network cell while in radio resource control inactive state and without transitioning to a radio resource control idle state.

Example 95. A non-transitory program storage device readable by a machine, tangibly embodying a program of instructions executable with the machine for performing operations, the operations including: receiving, from a network node providing access to another network cell, a path switch request while the terminal device is in radio resource control inactive state, the terminal device having reselected the another network cell while in radio resource control inactive state and without transitioning to a radio resource control idle state, from a network cell; receiving, from the network node providing access to the another network cell, a mobility registration update message; retaining at least one protocol data unit session and at least one data radio bearer setup prior to transitioning the terminal device to inactive state without performing radio resource control reestablishment, based on the mobility registration update message; and transmitting, to the terminal device either directly or through a network node providing access to the another network cell, a registration accept message.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash, hyphen, or number):
3GPP Third Generation Partnership Project
4G fourth generation
5G fifth generation
5GC 5G core network
AMF access and mobility management function
AS access stratum
ASIC application-specific integrated circuit
BSR buffer status report(ing)
CCCH common control channel
CHO conditional handover
CM connection management
CN core network
C-plane control plane
CPU central processing unit
CT1 core network and terminals meeting
CU central unit or centralized unit
DL downlink
DRB data radio bearer
DSP digital signal processor
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
enh enhancement
EPLMN equivalent PLMN
E-UTRA evolved universal terrestrial radio access, i.e., the LTE radio access technology
E-UTRAN E-UTRA network
F1 interface between the CU and the DU
FPGA field-programmable gate array
GEO geosynchronous earth orbit
gNB base station for 5G/NR, i.e., a node providing NR user plane and control plane protocol terminations towards the UE, and connected via the NG interface to the 5GC
I/F interface
I/O input/output
I-RNTI inactive-RNTI
LCID logical channel identifier
LMF location management function
LEO low earth orbit
LTE long term evolution (4G)
MAC medium access control
MEO medium earth orbit
MME mobility management entity
MRO mobility robustness optimization
MRU mobility registration update
msg3 or Msg3 message 3 in a 4-step random access procedure
NAS non access stratum
NCE network control element
ng or NG new generation
NGAP next generation application part
ng-eNB new generation eNB
NG-RAN new generation radio access network
NR new radio (5G)
NTN non terrestrial network
NW or N/W network
PDA personal digital assistant
PDCP packet data convergence protocol
PDSCH physical downlink shared channel
PDU protocol data unit
PHY physical layer
PLMN public land mobile network
PRACH physical random access channel
PUSCH physical uplink shared channel
RA registration area
RACH random access channel
RAM random access memory
RAN radio access network
RAN2 radio layer 2
RAN3 radio layer 3
RAN4 radio layer 4
RAT radio access technology
RAU registration area update
Rel-release
RLC radio link control
RNA RAN notification area
RNAU RAN notification area update
RNTI radio network temporary identifier
RO RACH occasion
ROM read-only memory
RNAU RAN notification area update
RP-RAN meeting
RRC radio resource control (protocol)
RU radio unit
Rx receiver or reception
SA system aspects
SDT small data transmission
SDU service data unit
SGW serving gateway
SI study item
SIE system information block
SMF session management function
SON self-organizing/optimizing network
SNPN standalone non-public network
SRB signaling radio bearer
TA tracking area
TN terrestrial network
TR technical report
TRP transmission reception point
TS technical specification
Tx transmitter or transmission
UAV unmanned aerial vehicle
UE user equipment (e.g., a wireless, typically mobile device)
UL uplink
UPF user plane function
U-plane user plane
WI work item
X2 network interface between RAN nodes and between RAN and the core network
Xn network interface between NG-RAN nodes
XnAP Xn Application Protocol

1. An apparatus, comprising:
at least one processor; and
at least one memory storing instructions that, when executed by the at least one processor, cause the apparatus at least to:
receive an indication from a network cell, the indication comprising at least one public land mobile network cell that supports inter public land mobile network radio resource control inactive state cell reselection; and
reselect another network cell while in radio resource control inactive state and without transitioning to a radio resource control idle state, the another network cell being among the indicated at least one public land mobile network cell that supports inter public land mobile network radio resource control inactive state cell reselection.

2.-3. (canceled)

4. The apparatus of claim 1, wherein the instructions, when executed by the at least one processor, cause the apparatus at least to:
receive the indication from an access and mobility management function of a core network through the network cell.

5. The apparatus of claim 1, wherein the instructions, when executed by the at least one processor, cause the apparatus at least to:
receive the indication within a system information block message.

6. The apparatus of claim 1, wherein the instructions, when executed by the at least one processor, cause the apparatus at least to:
receive the indication from a serving network node providing access to the network cell.

7. The apparatus of claim 6, wherein the instructions, when executed by the at least one processor, cause the apparatus at least to:
receive, while in radio resource control connected state, the indication from the serving network node before transitioning to the radio resource control inactive state.

8. The apparatus of claim 6, wherein the instructions, when executed by the at least one processor, cause the apparatus at least to:
receive the indication from the serving network node providing access to the network cell as part of a registration accept message.

9. The apparatus of claim 6, wherein the instructions, when executed by the at least one processor, cause the apparatus at least to:
receive the indication from the serving network node providing access to the network cell as part of a radio resource control release message with a suspend configuration.

10. The apparatus of claim 6, wherein the instructions, when executed by the at least one processor, cause the apparatus at least to:
receive the indication from the serving network node providing access to the network cell as part of broadcast signaling, wherein the broadcast signaling comprises one of: a system information block type 1 message, or a network specific system information block type 19 message.

11. (canceled)

12. The apparatus of claim 1, wherein the instructions, when executed by the at least one processor, cause the apparatus at least to:
receive the indication with dedicated signaling, the dedicated signaling comprising a radio resource control connection reconfiguration message.

13. The apparatus of claim 1, wherein the instructions, when executed by the at least one processor, cause the apparatus at least to:
transmit a cause value to a network node providing access to the another network cell, when the network node providing access to the another network cell is different from a serving network node providing access to the network cell, wherein the cause value is configured to be used for a non-access stratum registration update procedure.

14. (canceled)

15. The apparatus of claim 13, wherein the instructions, when executed by the at least one processor, cause the apparatus at least to:
transmit the cause value within a radio resource control resume request message.

16. The apparatus of claim 15, wherein the instructions, when executed by the at least one processor, cause the apparatus at least to:
transmit the cause value within the radio resource control resume request message using a dedicated logical channel identifier.

17. The apparatus of claim 1, wherein the instructions, when executed by the at least one processor, cause the apparatus at least to:
initiate, with a network node providing access to the another network cell, a small data transmission procedure for a mobility registration update while in the radio resource control inactive state.

18. The apparatus of claim 17, wherein the instructions, when executed by the at least one processor, cause the apparatus at least to:
transmit, to the network node providing access to the another network cell during the mobility registration update, a registration request with mobility update non-access stratum message as a message 3 of a 4-step random access channel procedure, based on the message 3 being of a size sufficient to accommodate the non-access stratum message; andor
transmit, to the network node providing access to the another network cell, a buffer status report in the message 3 requesting an additional uplink grant, based on the message 3 not being of a size sufficient to accommodate the non-access stratum message.

19. The apparatus of claim 17, wherein the instructions, when executed by the at least one processor, cause the apparatus at least to:
indicate, to the network node providing access to the another network cell during the mobility registration update, a size for message 3 of a 4-step random access channel procedure for accommodating a registration request with mobility update non-access stratum message.

20. The apparatus of claim 1, wherein the instructions, when executed by the at least one processor, cause the apparatus at least to:
receive, with a physical downlink shared channel transmission, a registration accept message from a network node providing access to the another network cell.

21. The apparatus of claim 1, wherein the instructions, when executed by the at least one processor, cause the apparatus at least to:
receive a registration accept message from an access and mobility management function, based on the reselection to the another network cell while in radio resource control inactive state.

22. An apparatus, comprising:
at least one processor; and
at least one memory storing instructions that, when executed by the at least one processor, cause the apparatus at least to:
receive, with a network node from a terminal device, a registration message, the network node providing access to a network cell; and
transmit, to the terminal device, an indication comprising at least one public land mobile network cell that supports inter public land mobile network radio resource control inactive state cell reselection;
wherein the indication is configured to be used with the terminal device to reselect another network cell while the terminal device is in radio resource control inactive state and without transitioning to a radio resource control idle state, the another network cell being among the at least one public land mobile network cell that supports inter public land mobile network radio resource control inactive state cell reselection.

23.-25. (vanceled)

26. An apparatus, comprising:
at least one processor; and
at least one memory storing instructions that, when executed by the at least one processor, cause the apparatus at least to:
receive, from a terminal device, a cause value configured to be used for a registration update procedure when the terminal device while in radio resource control inactive state, and without transitioning to a radio resource control idle state, is reselecting another network cell from a network cell;
store the cause value within a resume request;
retain the terminal device in the radio resource control inactive state with an updated suspend configuration; and
transmit, to the terminal device, a physical downlink shared channel transmission comprising a registration accept message.

27. The apparatus of claim 26, wherein the instructions, when executed by the at least one processor, cause the apparatus at least to:
receive, from a terminal device during a small data transmission procedure, a mobility registration update non-access stratum message;
initiate a path switch procedure with an access and mobility management function, based on the stored cause while retaining the terminal device in radio resource control inactive state; and
transmit, to the access and mobility management function, a next generation application protocol uplink non-access stratum transport message comprising the mobility registration update non-access stratum message, while retaining the terminal device in radio resource control inactive state.
